(19) United States
(12) Patent Application Publication
(10) Pub. No.: US 2006/0093189 A1
(43) Pub. Date: May 4, 2006

(54) Movement identification apparatus

(75) Inventors: Noriji Kato, Kanagawa (JP); Masahiro Maeda, Kanagawa (JP); Hitoshi Ikeda, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/157,797

(22) Filed: Jun. 22, 2005

(30) Foreign Application Priority Data
Nov. 4, 2004 (JP) 2004-320191

(51) Int. Cl. G06K 9/00

(52) U.S. Cl. 382/107

(57) ABSTRACT

A movement identification apparatus, which identifies a movement of a moving body based on a moving picture obtained by a camera, includes a model holding unit that holds a movement model representing a feature of a movement of a movable portion of a reference moving body linked to a type of movement, a state detector that detects state information representing a movement of a movable portion of a target moving body identical to or the same as the obtained reference moving body in the moving picture, and a movement determination unit that determines a type of movement of the target moving body based on a similarity between the detected state information and the movement model.

### BACKGROUND OF THE INVENTION

1. Field of the Invention

The present invention relates to a technique for identifying the movement of a moving body, such as a person or a robot, in a moving picture. The present invention relates in particular to a technique that can simplify the construction of a movement model used for movement identification, and can improve the accuracy with which movement is identified.

2. Description of the Related Art

Moving pictures obtained by cameras are used not only for security management, but also for various other purposes, such as an analysis of the activities of persons employed in offices and the operational management of robots working in factories.

The modes commonly used for recording moving pictures include a mode for simply monitoring and recording images, and a mode for identifying the movements of a moving body, such as those of a person.

To identify, for example, the movement of a hand of a person, models of hand movements are prepared. Then, feature values are calculated, based on the positions of a hand, an elbow and a shoulder in an image and are compared with feature values obtained using the models, and the movement of a hand in the image is analyzed (see JP-A-8-320920).

Furthermore, the following technique is known as an example element technique that can be used for identifying a moving body in a moving picture.

According to this technique, a skin color area in an image is detected and used to identify a necessary portion, such as the face of a person. Using this technique, a person, or the face of the person, can be detected in the image (see JP-A-2000-105819).

Further, another technique is known whereby feature points are extracted from an image of a face, and based on the feature points, the image of the face is compared with a previously prepared template. Using this technique, a face in an image can be detected, or identify of two face images can be determined (see “Face Recognition By Elastic Bunch Matching”, Laurenz Wiskott, Jean-Marc Fellous, Norbert Krouger and Christoph von der Malsburg, Proc. 7th Intern. Conf. on Computer Analysis of Image and Patterns 1997).

An additional technique is known whereby, to make a personal identification based on an image of a face, pattern information representing a face is mapped to a defined space to enhance individual differences, and in this space, the image of the face is compared with a previously prepared template. Using this technique, the face in the image can be detected, or identity of two face images can be determined (see “Eigenfaces for Recognition”, Matthew A. Turk and Alex P. Pentland, Journal of Cognitive Neuroscience Vol. 3, No. 1, pp. 71-86 (1991)).

Another technique is known whereby an individual can be identified based on individual differences in the three-dimensional shape of a face, instead of the shape and the arrangement of a characteristic portion, such as the eye area, the nose or the mouth. Using this technique, a face can be detected in an image, or identity of two face images can be determined (see JP-A-2-311962).

In order to detect the movement of a body in a moving picture, conventionally, multiple movement models must be prepared, as described in JP-A-8-320920, to construct a movement model that can be used in common for an unspecified number of people.

However, since there are individual differences in a single activity, such using a telephone to make a call, it is difficult to form a movement model that can be used in common for an unspecified number of people, and it is also difficult for a highly accurate movement recognition process to be performed.

### SUMMARY OF THE INVENTION

To resolve the conventional shortcoming, the invention simplifies the construction of a movement model, and improves the accuracy at which the movement of a moving body is identified.

The present invention is provided as a movement identification apparatus that identifies the movement of a body based on a moving picture obtained by a camera, or as an apparatus that prepares a movement model used for the identification of the movement of the body. The present invention is also provided as a computer program that permits these apparatuses to be constituted as a computer, or a movement identification method that is executed by these apparatuses.

According to an aspect of the present invention, a movement identification apparatus, which identifies a movement of a moving body based on a moving picture obtained by a camera, includes a model holding unit that holds a movement model representing a feature of a movement of a movable portion of a reference moving body linked to a type of movement, a state detector that detects state information representing a movement of a movable portion of a target moving body identical to or the same as the obtained reference moving body in the moving picture, and a movement determination unit that determines a type of movement of the target moving body based on a similarity between the detected state information and the movement model.

According to another aspect of the present invention, a movement model registration apparatus, which registers a movement model to be referred to identify a movement of a moving body based on a moving picture, includes a state detector that detects state information representing a movement of a movable portion of the obtained moving body in the moving picture, a model generator that generates a movement model representing a feature of the movement of the movable portion of the moving body from the detected state information, and a model holding unit that holds the generated movement model linked to a movement type for the moving body.

According to yet another aspect of the present invention, a movement identification apparatus, which identifies a movement of a moving body based on a moving picture obtained by a camera, includes a first state detector that detects state information representing a movement of a movable portion of a reference moving body obtained by the camera in a moving picture, a model generator that generates a movement model representing a feature of the movement of the movable portion of the reference moving body from the detected state information, a model holding unit that holds the generated movement model linked to a type of movement for the reference moving body, a second state detector that detects state information representing a movement of a movable portion of a target moving body identical to or the same as the obtained reference moving body in the moving picture, and a movement determination unit that determines a type of movement for the target moving body based on a similarity between the detected state information and the movement model.

### BRIEF DESCRIPTION OF THE DRAWINGS

Embodiments of the present invention will be described in detail based on the following figures, wherein:

FIG. 1 is a diagram showing the configuration of a movement identification apparatus according to one embodiment of the present invention;

FIG. 2 is a diagram showing an example screen display for the movement identification apparatus according to the embodiment of the invention;

FIG. 3 is a flowchart for explaining the movement model registration processing according to the embodiment of the invention;

FIG. 4 is a diagram for explaining a movement model according to the embodiment of the invention; and

FIG. 5 is a flowchart for explaining the movement identification processing according to the embodiment of the invention.

### DETAILED DESCRIPTION OF THE INVENTION

The present invention will now be specifically explained by referring to one embodiment for identifying, as a moving body, a movement type of person that has been photographed and is in a moving picture.

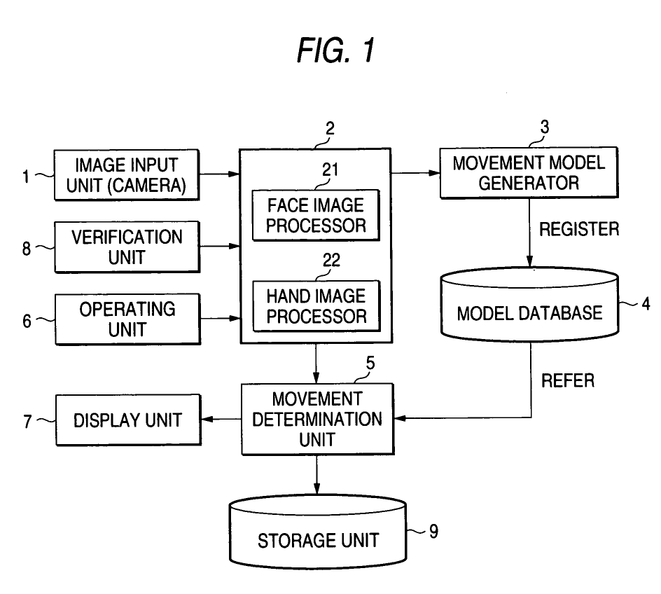

FIG. 1 is a diagram showing an example configuration for a movement identification apparatus according to the embodiment of the invention. The movement identification apparatus in this example also includes a movement model registration unit. In this embodiment, a movement model registration unit and a movement identification unit may be separately provided, and a movement model registered by the movement model registration apparatus may be employed by the movement identification apparatus.

The movement identification apparatus in this embodiment includes a video camera (image input unit) 1, for photographing a moving picture, a state detector 2, for detecting state information that represents the movements of movable portions, such as the face and hands of a person (a reference moving body or a target moving body) in a moving image transmitted by the video camera 1, a movement model generator 3, for employing the detected state information to generate a movement model that represents the characteristics of the movements of the movable portions of the person, and a model database 4, in which the movement model is stored with linking to the movement type of the person. In the registration mode, a movement model that represents the characteristic of a movement of a movable portion of a person (reference moving body) in a moving picture is generated based on the state information detected based on the image of the reference moving body. This movement model is registered in the model database 4 with linking to the type of movement.

The movement identification apparatus of this embodiment further includes a movement determination unit 5, for determining the type of movement of the person in the moving picture based on the similarity between the state information detected by the state detector 2 and the movement model stored in the model database 4. In the movement identification mode, the state information detected from the image of the person (target moving body) in the moving picture is employed to examine the movement model of the reference moving body, which is the same person as the target person registered in the model database 4. Then, the type of movement of the target person is determined.

The movement identification apparatus in this embodiment also includes an operating unit 6, including a keyboard and a mouse for accepting an instruction from a user concerning a mode selection and registration, a display unit 7, for presenting a user input screen and displaying the identification results on the screen, and a well known verification unit 8, for accepting, from a user, information, such as a user ID or a fingerprint, to be used for identifying the user.

The verification unit 8 is required to guarantee the identify of the person when plural users commonly use the movement identification apparatus, and is not necessarily provided when the movement identification apparatus is for the exclusive use of an individual user.

The state detector 2 detects, as state information representing the movements of the movable portions of the moving body, the coordinate position, the size and the direction of the face of a person and the coordinate positions of the hands. The state detector 2 includes a face image processor 21 for detecting state information related to a face in a moving picture, and a hand image processor 22 for detecting state information related to hands in a moving picture.

In this embodiment, the state information representing the movements of the face and the hands of the person is employed, however, for the present invention, state information can be employed for various other portions of a person that are moved.

Using the method disclosed, for example, in JP-A-2000-105819, JP-A-2-311962, “Face Recognition By Elastic Bunch Matching”, Laurenz Wiskott, et al. or “Eigenfaces for Recognition”, Matthew A. Turk, et al., the face image processor 21 detects the face image portion of the photographic image of a person in a moving picture, and obtains the coordinate position, the size and the direction of the face of the person in the moving picture frame.

By the method disclosed in, for example, JP-A-8-320920, the hand image processor 22 detects the hand image portion of the photographic image of a person in a moving picture, and obtains the coordinate positions of the hands of the person in the moving picture frame.

The movement model generator 3 approximates the distribution of a set of state information (the coordinate position, the size and the direction of the face, and the coordinate positions of the hands) that has been detected by the state detector 2 during a predetermined frame period (time), and generates one movement model. In this case, for example, a method can be employed whereby one Gaussian distribution is employed to approximate the distribution, and the obtained average and a covarience matrix are regarded as movement models. Or another distribution, such as a mixed Gaussian distribution, can be employed.

The model database 4 is constituted by a readable and writable memory, and is used to store a movement model generated by the movement model generator 3.

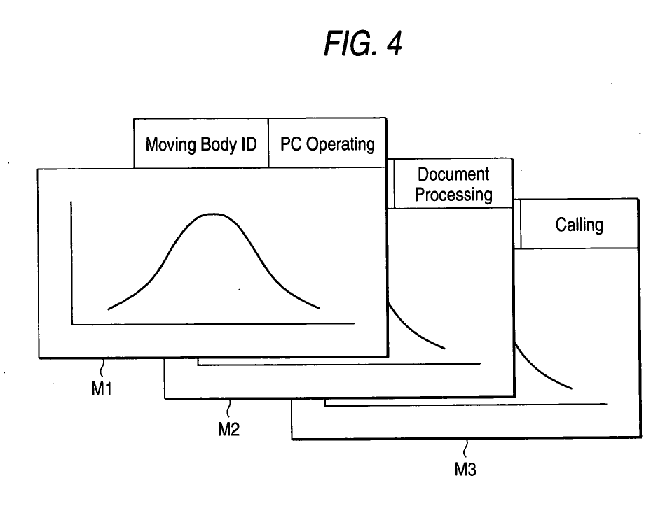

As will be described later, in the movement model registration mode, the movement type of the photographic image of a person in a moving picture is entered through the operating unit 6, and as is shown in FIG. 4, generated movement models M1, M2 and M3 are stored in the model database 4, with linking to a movement type that is entered, such as currently operating a PC, performing document processing, or making a call using a phone.

When plural users commonly employ the movement identification apparatus that uses the verification unit 8, a moving body ID for identifying a user, need only be stored with linking to each movement model, so that in the movement identification mode, a movement model generated based on the movement of the verified user can be employed for an identification determination.

The movement determination unit 5 compares the set of state information (the coordinate position, the size and the direction of the face and the coordinate positions of the hands) for the person (the target person) detected by the state detector 2 with the movement model for the person (reference moving body) that is stored in the model database 4 and is the same as the target person. When between the two a predesignated level of similarity or higher is present, the movement type linked with the movement model is output to the display unit 7 and is displayed. During this comparison process, when the movement model is represented by one Gaussian distribution, the Mahalanobis distance between the state information set and the center of the movement model is calculated by using the standard deviation for the movement model, and when the distance is equal to or shorter than a previously designated threshold value, it is determined that the movement type is for the pertinent movement model.

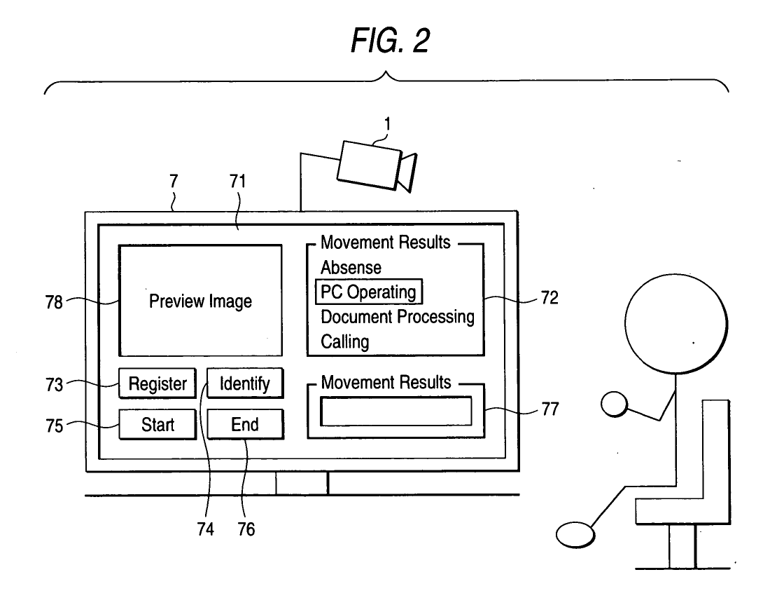

As is shown in FIG. 2, the display unit 7 is the display device provided for a personal computer (a PC) constituting the movement identification apparatus of this embodiment. Provided on a screen 71 are an area 72, for displaying a movement type as determined by the movement determination unit 5, various areas 73 to 77, for entering instructions required for the movement model registration mode and the movement identification mode, and a preview area 78 for displaying a moving picture obtained by the video camera 1.

The area 73 is a button for selecting the movement model registration mode, the area 74 is a button for selecting the movement identification mode, the area 75 is a button for starting the mode processing, the area 76 is a button for ending the mode processing, and the area 77 is a column for entering a movement type to be linked with a movement model in the movement model registration mode. The user employs the operating unit 6 to enter necessary data in these areas.

According to this embodiment, in the movement identification mode, processing is performed to moving pictures that have been received during a period beginning upon the depression of the start button 75 and ending upon the depression of the end button 76. In the registration mode, however, processing begins when the registration button 73 is pressed and continues until a predetermined time has elapsed. That is, in the registration process, a predetermined period of time is designated for the processing of a required number (time) of moving picture frames, so that the amount of state information needed for the generation of the movement model can be obtained from the moving picture.

The processing time for the registration mode may also be controlled by using the start button 75 and the end button 76. Furthermore, processing in the movement identification mode may be performed for a predetermined period by depressing the identification button 74.

The movement types determined by the movement determination unit 5 may be stored in an accumulation unit 9, and the accumulated information may be employed, for example, for analyzing the person's activities throughout a day.

The state detector 2, the movement model generator 3, the model database 4 and the movement determination unit 5 can be individually constituted by special hardware. And in this embodiment, these components are provided when the computer constituting the movement identification apparatus executes a program related to the present invention.

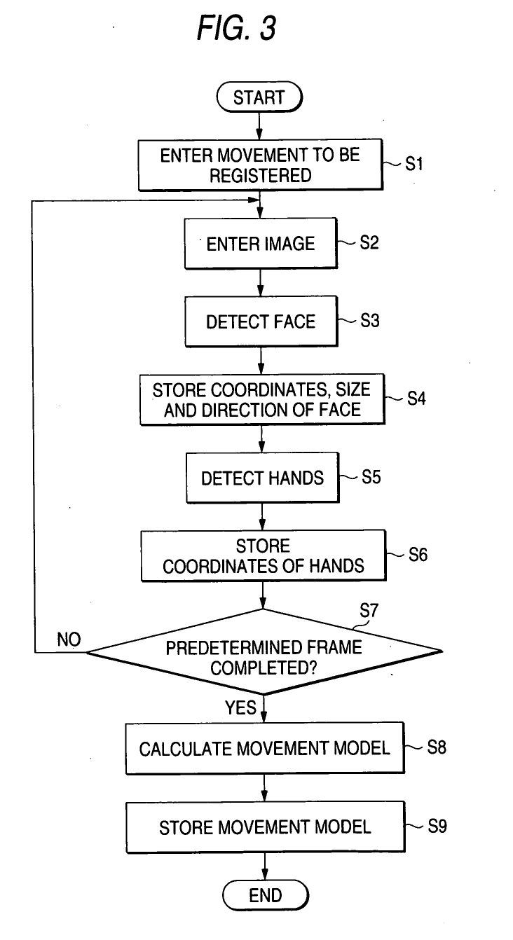

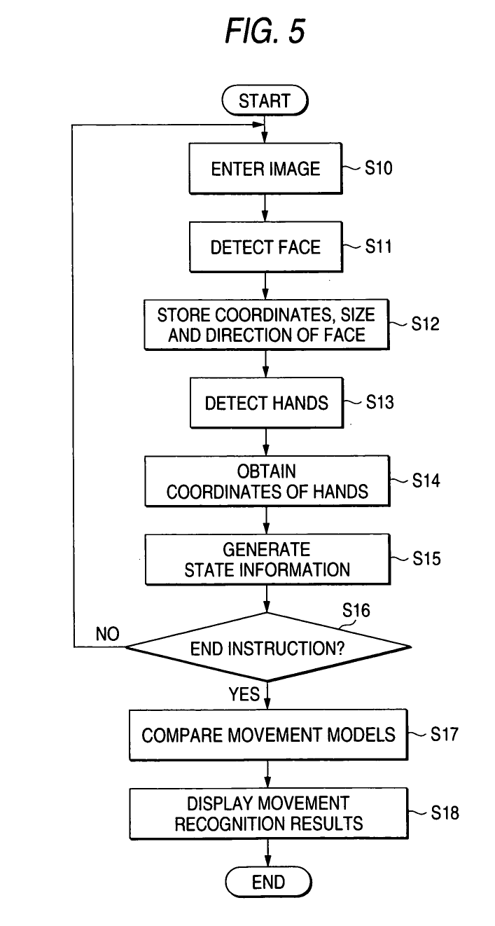

The movement identification apparatus for this embodiment performs the movement model registration processing shown in FIG. 3, and the movement identification processing shown in FIG. 5.

When a user employs the operating unit 6 and presses the registration button 73 or the identification button 74, thereby instructing the selection of the registration mode or the movement identification mode, either the movement model registration processing or the movement identification processing is performed.

In the registration mode, when the processing is initiated by the pressing the registration button 73, as is shown in FIG. 3, information for a movement type to be registered is accepted from the user (step S1). That is, the user (the reference person in this case) employs the operating unit 6 to enter in the movement registration area 77 on the screen 71 the type of a movement that the user is going to do, so that information for this movement is registered.

Plural buttons corresponding to plural movement types that can be registered may be previously prepared in the movement registration area 77, so that the user can employ these buttons to select and enter the movement type information that is to be registered.

Then, for a moving picture that includes the image of the user (the reference person) and was photographed by the video camera 1, processing of each frame of the moving picture is performed by the state detector 2 (step S2). That is, the face image processor 21 detects, in the moving picture frames, the face image portions for the reference person (step S3), and detects in the face image portions the coordinate position, the size and the direction of the face and stores them (step S4). Meanwhile, the hand image processor 22 detects the hand image portions for the reference person in the moving picture frames (step S5), and detects and stores the coordinate positions of the hands (step S6).

These processes at steps S2 to S6 are performed for each, individual frame of the moving picture (step S7). And when all the frames have been processed, a set of state information (the coordinate position, the size and the direction of the face and the coordinate positions of the hands) detected by the state detector 2 is output to the movement model generator 3.

Upon receiving the state information set, the movement model generator 3 calculates a movement model based on the state information and stores the movement model in the model database 4, as is shown in FIG. 4, linked to the movement type information that is entered in the movement registration area 77 (step S9).

Therefore, when the user designates the type of movement and performs the pertinent movement in front of the video camera 1, a movement model for the user, as a reference person, is generated and is registered with linking to the designated movement type.

In the movement identification mode, when, as is shown in FIG. 5, a user depresses the identification button 74 and the start button 75, the processing is initiated for a moving picture that includes an image of the user (in this case, a target person who is identical to the reference person) who has been photographed by the video camera 1 during a period that continues until the end instruction (step S16) is entered by the depression of the end button 76, the state detector 2 sequentially processes each moving picture frame (step S10).

That is, the face image processor 21 detects the face image portion for the target person in each moving picture frame (step S11), and from the face image portion, obtains the coordinate position, the size and the direction of the face (step S12). Further, the hand image processor 22 detects the hand image portion for the target person in each moving picture frame (step S13) and obtains the coordinate positions of the hands (step S14). Thereafter, state information (the coordinate position, the size and the direction of the face and the coordinate positions of the hands) detected by the state detector 2 is combined to form a single vector (step S15).

The processes at steps S10 to S15 are performed for each frame in a moving picture (step S16), and when the end instruction is entered, the state detector 2 outputs, to the movement determination unit 5, the state information vector.

Upon receiving the state information vector, the movement determination unit compares the state information vector with movement models stored in the model database 4 (step S17), and outputs, to the display unit 7 and the accumulation unit 9, information for the type of movement that is provided for a movement model that satisfies a predetermined similarity level. Then, the display unit 7 displays the received information for the movement type in the movement results area 72 on the screen 71 (step S18).

Therefore, when the user moves in front of the video camera 1, the movement of the user is determined based on the movement model for this person, and the results are output. Since the movement model for the same person is employed for the determination, highly accurate determination results can be obtained, and since the processing is performed for the same person, the movement model can be easily prepared without taking individual, personal differences into account.

In this embodiment, all the previously registered movement type information is displayed in the movement result area 72, and on the screen, the movement type information determined by the movement determination unit 5 is highlighted. However, the method for displaying the determination results is not especially limited.

In the embodiment, the moving body has selected and started the registration mode and the identification mode. However, a third party, such as a manager, may be in charge of these operations, or the operations may be automatically performed within a predetermined time zone.

Further, a person has been employed as an example moving body. However, the present invention can also be applied for moving bodies other than human beings, like animals or robots, that are controlled by a third party or that are controlled automatically.

Furthermore, in the embodiment, a reference moving body and a target moving body are identical. However, the present invention can also be applied for a case wherein a reference moving body and a target moving body are similar to each other. When the determination is performed within a range wherein the moving bodies are similar, accurate results can be obtained. In addition, the multiplicity of uses (community) required of the movement model is reduced, and the construction of a movement model is simplified.

According to one aspect of the invention, a movement identification apparatus, which can identify the movements of various moving bodies, such as persons and robots, based on moving pictures obtained by cameras, includes a model holding unit, for holding, linking to movement types, movement models representing movement characteristics of movable portions (e.g., the face and a part of the limbs of a person) of a reference moving body, a state detector, for detecting, in a moving picture, state information (e.g., position information and angle information for the face and a part of the limbs of the person) that represents the movement of a movable portion of a target moving body that is identical to or the same as the reference moving body that is obtained, and a movement determination unit, for determining a type of movement of the target moving body based on a similarity between the detected state information and a movement model.

Since the movement type of the target moving body is determined based on the movement model of the reference moving body that is the identical or the same type of moving body, the affect of individual differences (moving body difference) of the movement manner can be eliminated, or minimized to the extent possible, and the movement type can be accurately identified. Furthermore, since the movement model need not be prepared for use in common for unspecified moving bodies, the movement model can be easily constructed.

For this invention, in order to eliminate individual differences in the manner of movement, it is preferable that the reference moving body be identical to the target moving body, e.g., the employment of a movement model, prepared in accordance with the movement of a specific person, that is used to identify the type of a succeeding movement of the person. The reference moving body may also be the same type as the target moving body, so that a movement model prepared in accordance with the movement of a robot that performs a specific operation can be employed to identify the type of a succeeding movement of the same type of robot that performs the same type of operation. Also, with this arrangement, the practically permissible identification accuracy can be obtained.

The movement identification apparatus of the invention may further include a verification unit, for accepting information for identifying a target moving body. Preferably, the movement determination unit may determine the type of movement of the target moving body based on the similarity between the detected state information and a movement model, of the reference moving body that is identical to the target moving body. With this arrangement, of the movement models prepared based on plural reference moving bodies, a movement model that is prepared based on the reference moving body that is the same as the target moving body can be employed. As a result, the affect on the movement manner of individual differences can be eliminated, and the movement type can be accurately identified.

According to another aspect of the invention, a movement model registration apparatus, which registers a movement model that is to be referred to for identifying a movement of a moving body based on a moving picture, includes a state detector, for detecting state information representing the movements of movable portions of a moving body in a moving picture, a model generator, for employing the detected state information to generate a movement model that represents characteristics of the movements of the movable portions of the moving body, and a model holding unit, for holding the movement model linked to a movement type for the moving body.

For the movement model registration apparatus of the invention, it is preferable that the model generator generate the movement model in accordance with a standard deviation in the state information. It is also preferable that the movement model registration apparatus further includes an operation unit, for accepting a movement type from a user. Preferably, the model holding unit holds the movement model linked to the movement type accepted by the operation unit.

The present invention can be constituted as a movement identification apparatus that includes this movement model registration apparatus. This movement identification apparatus includes a state detector, for detecting state information representing movements of movable portions of a photographed reference moving body in a moving picture, a model generator, for employing the detected state information to generate a movement model that represents characteristics of the movements of the movable portions of the reference moving body, a model holding unit, for holding the movement model linked to a movement type for the reference moving body, a movement determination unit, for determining, when the state detector detects state information representing the movements of movable portions of a target moving body that is identical to, or of the same type, as the reference moving body in the moving picture, a movement type for the target moving body based on a similarity between the detected state information and the movement model.

In this case, a state detector for detecting the state information for the reference moving body may be separately provided by a state detector for detecting the state information for the target moving body. However, with the above described arrangement, the same function unit can be used in common.

According to the invention, when a movement identification apparatus is provided for each moving body by employing, for example, a personal computer used by the same person, the reference moving body and the target moving body can always be processed as being identical.

According to the invention, the movement type of the target moving body is determined based on the movement model of the reference moving body that is identical to, or of the same type, as the target moving body, the affect of individual differences on the movement manner can be eliminated, or can be suppressed to the extent possible, and the movement type can be accurately identified. Furthermore, since the movement model need not be prepared for use in common for unspecified moving bodies, the movement model can be easily prepared.

The entire disclosure of Japanese Patent Application No. 2004-320191 filed on Nov. 4, 2004 including specification, claims, drawings and abstract is incorporated herein by reference in its entirety.

What is claimed is:

1. A movement identification apparatus, which identifies a movement of a moving body based on a moving picture obtained by a camera, comprising:
a model holding unit that holds a movement model representing a feature of a movement of a movable portion of a reference moving body, the movement model is linked to a type of movement;
a state detector that detects state information representing a movement of a movable portion of a target moving body identical to or the same as the obtained reference moving body in the moving picture; and
a movement determination unit that determines a type of movement of the target moving body based on a similarity between the detected state information and the movement model.

2. The movement identification apparatus according to claim 1, further comprising:
a verification unit that accepts information to identify the target moving body,
wherein the movement determination unit determines the type of movement of the target moving body based on a similarity between the detected state information and a movement model of a reference moving body identical to the target moving body.

3. A movement model registration apparatus, which registers a movement model to be referred to identify a movement of a moving body based on a moving picture, comprising:
a state detector that detects state information representing a movement of a movable portion of the obtained moving body in the moving picture;
a model generator that generates a movement model representing a feature of the movement of the movable portion of the moving body from the detected state information; and
a model holding unit that holds the generated movement model linked to a movement type for the moving body.

4. The movement model registration apparatus according to claim 3,
wherein the model generator generates the movement model in accordance with a standard deviation in the state information.

5. The movement model registration apparatus according to claim 3, further comprising:
an operation unit that accepts a movement type from a user,
wherein the model holding unit holds the movement model linked to the movement type accepted by the operation unit.

6. A movement identification apparatus, which identifies a movement of a moving body based on a moving picture obtained by a camera, comprising:
a first state detector that detects state information representing a movement of a movable portion of a reference moving body obtained by the camera in a moving picture;
a model generator that generates a movement model representing a feature of the movement of the movable portion of the reference moving body from the detected state information;
a model holding unit that holds the generated movement model linked to a type of movement for the reference moving body;
a second state detector that detects state information representing a movement of a movable portion of a target moving body identical to or the same as the obtained reference moving body in the moving picture; and
a movement determination unit that determines a type of movement for the target moving body based on a similarity between the detected state information and the movement model.

7. A storage medium readable by a computer, the storage medium storing a program of instructions executable by the computer to perform a function for identifying a movement of a moving body based on a moving picture obtained by a camera, the function comprising the steps of:
detecting state information representing a movement of a movable portion of a target moving body obtained by the camera in a moving picture;
referring a model holding unit that stores a movement model representing a feature of a movement of a movable portion of a reference moving body identical to or the same as the target moving body linked to a type of movement; and
determining a type of movement of the target moving body based on a similarity between the detected state information and the movement model.

8. A storage medium readable by a computer, the storage medium storing a program of instructions executable by the computer to perform a function for registering a movement model to be referred to identify a movement of a moving body based on a moving picture, the function comprising the steps of:
detecting state information representing a movement of a movable portion of the obtained moving body in the moving picture;
generating a movement model representing a feature of the movement of the movable portion of the moving body from the detected state information; and
holding the generated movement model linked to a type of movement for the moving body.

9. A movement identification method, for identifying a movement of a moving body based on a moving picture obtained by a camera, comprising:
detecting state information representing a movement of a movable portion of a target moving body obtained by the camera in a moving picture;
referring a model holding unit that stores a movement model representing a feature of a movement of a movable portion of a reference moving body identical to or the same as the target moving body linked to a type of movement;
determining a type of movement of the target moving body based on a similarity between the detected state information and the movement model; and
outputting the determined type of movement.

10. A movement identification method, for identifying a movement of a moving body based on a moving picture photographed by a camera, comprising:
detecting state information representing a movement of a movable portion of the obtained moving body in the moving picture;
generating a movement model representing a feature of the movement of the movable portion of the moving body from the detected state information;
holding the generated movement model linked to a type of movement for the reference moving body;
detecting state information representing a movement of a movable portion of a target moving body identical to or the same as the obtained reference moving body in the moving picture;
determining a type of movement for the target moving body based on a similarity between the detected state information and the movement model of the reference moving body identical to or the same as the target moving body; and
outputting the determined type of movement.
